(19) United States
(12) Patent Application Publication
(10) Pub. No.: US 2008/0235754 A1
(43) Pub. Date: Sep. 25, 2008

(54) Methods and apparatus for enforcing launch policies in processing systems

(76) Inventors: Willard M. Wiseman, Tigard, OR (US); Simon P. Johnson, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/725,349

(22) Filed: Mar. 19, 2007

(51) Int. Cl. G06F 17/00; G06F 12/00; G06F 9/445

(52) U.S. Cl. 726/1; 711/104; 718/1

(57) ABSTRACT

A processing system has a processing unit, nonvolatile storage, and secure nonvolatile memory with inherent access control. The nonvolatile storage includes an authenticated code (AC) module, a launch policy setting, and a second code module. The secure nonvolatile memory includes an integrity metric for the launch policy setting. When executed by the processing unit, the AC module computes a new integrity metric for the launch policy setting, and uses the new integrity metric for the launch policy setting and the integrity metric for the launch policy setting to determine whether the launch policy setting should be trusted. The AC module may also compute a new integrity metric for the second code module, and may use the launch policy setting and the new integrity metric for the second code module to determine whether the second code module should be allowed to execute.

### FIELD OF THE INVENTION

The present disclosure relates generally to the field of data processing, and more particularly to methods and related apparatus for enforcing launch policies in processing systems.

### BACKGROUND

A processing system may include hardware resources, such as a central processing unit (CPU), random access memory (RAM), and nonvolatile (NV) memory. The processing system may also include software resources, such as a basic input/output system (BIOS) and a virtual machine monitor (VMM). When the computer system is started or reset, it may load the BIOS, and then the VMM. The VMM may then create one or more virtual machines, and the virtual machines may boot to different guest operating systems (OSs) or to different instances of the same OS.

In addition to RAM and one or more CPUs, a processing system may include a security coprocessor, such as a trusted platform module (TPM). A TPM is a hardware component that resides within a processing system and provides various facilities and services for enhancing the security of the processing system. For example, a TPM may be implemented as an integrated circuit (IC) or semiconductor chip, and it may be used to protect data and to attest to the configuration of a platform. A TPM may be implemented in accordance with specifications such as the Trusted Computing Group (TCG) TPM Specification Version 1.2, dated Oct. 2, 2003 (hereinafter the “TPM specification”), which includes parts such as Design Principles, Structures of the TPM, and TPM Commands. The TPM specification is published by the TCG and is available from the Internet at www.trustedcomputinggroup.org/home.

The sub-components of a TPM may include an execution engine and secure NV memory or storage. The secure NV memory is used to store sensitive information, such as encryption keys, and the execution engine protects the sensitive information according to the security policies dictated by the TPM's control logic. That is, an inherent feature of the TPM is the control logic that implements access controls which prevent unauthorized access to the NV memory.

In a platform with a TPM, platform measurements and encryption can be used to seal sensitive information or secrets to the TPM. For instance, in a processing system running a VMM, secrets can be sealed to the TPM using measurements of the VMM and other platform components. The TPM may prevent the secrets from subsequently being released or unsealed from the TPM unless measurements of the current VMM and other platform components are verified to match the measurements that were used for sealing.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting a suitable data processing environment in which certain aspects of an example embodiment of the present invention may be implemented; and

FIG. 2 depicts a flowchart of an example embodiment of a process for enforcing launching policies in the processing system of FIG. 1.

### DETAILED DESCRIPTION

A conventional processing system may include mechanisms for measuring a VMM. However, the processing system may not actually determine whether or not the VMM should be trusted until after the VMM has been launched and an integrity challenge has then been made on the platform. This allows a situation known as hyper-jacking to exist, where the VMM underneath an OS can be replaced by malware, and the malware may only be discovered, if at all, after it has launched.

In addition, the processing system may lack the capability to monitor system management interrupt (SMI) transfers. The lack of an SMI transfer monitor (STM) may make the platform vulnerable to attacks against system management mode (SMM). (SMI transfer monitors may also be referred to as SMM transfer monitors.) One approach to combating SMM-based attacks is to use a static root of trust (SRT) mechanism to establish measurements of the BIOS and SMM code.

It would be beneficial if the processing system could locally prevent unauthorized SMM code and unauthorized VMMs from executing, rather than relying on an attestation to a third party once the measured code is executing.

The present disclosure describes a launch control policy (LCP) mechanism which uses the access control features of the NV storage of the TPM to provide the platform supplier, the platform owner, or both, with the ability to control which software is measured and executed when the processing system executes an instruction for launching a VMM or for activating or enabling virtualization. For instance, in a processing system that uses Intel® architecture (IA), the LCP(s) may be enforced when the processing system executes the IA instruction GETSEC[SENTER].

During configuration of the processing system, data that defines the desired LCP(s) may be saved to NV storage of the processing system. In addition, the storage features of the TPM may be used to provide an extensible system of LCP data measurements or descriptors which, due to the access control features of the TPM, can only be set or altered by the platform supplier or the platform owner. Platform suppliers may include entities such as original equipment manufacturers (OEMs) which assemble and sell processing systems. Platform owners may include customers of platform supplier. For instance, the information technology (IT) department of a company may serve as the platform owner for the processing systems that the company acquires and provides to its employees for business use.

In an example embodiment, the LCP(s) are then interpreted and enforced by a secure initialization (SINIT) authenticated code (AC) module, which is only executed during the execution of the GETSEC[SENTER] instruction. In an example embodiment, a format such as the one described in the LaGrande Technology Preliminary Architecture Specification, dated September 2006 (hereinafter “the LTPA Specification”), is used for the AC module. The LTPA Specification is currently available from the Internet at www.intel.com/technology/security/downloads/LT_spec_{—}0906.pdf. For purposes of this disclosure, LaGrande Technology may also be referred to as Intel® Trusted Execution Technology (TXT). The Intel® Trusted Execution Technology Preliminary Architecture Specification, dated November 2006, (hereinafter the “Intel® TXT Specification”) also provides details for implementing and/or using security features such as STMs, the secure entry or SENTER instruction, etc. The Intel® TXT Specification is currently available at www.intel.com/technology/security. The Intel® TXT specification may provide more current information, for some or all of the features described in the LTPA Specification.

When GETSEC[SENTER] is executed or invoked, one of its parameters is a pointer to the next block of code to execute immediately following the successful completion of the GETSEC[SENTER] instruction. In a conventional system, SINIT only computes an integrity metric or hash of the code block identified by the GETSEC[SENTER], and then SINIT passes control of the processor to the measured code block.

By contrast, when implementing the LCP feature, after SINIT computes the integrity metric for the identified code block, SINIT then checks the LCP data to determine whether the measured code block should be trusted. Furthermore, the SINIT code verifies the integrity of the LCP data, by reading the TPM's access controlled NV interface. In this way, the platform supplier's and/or platform owner's policies are enforced by SINIT. If the processing system determines that the measured code bock should not be trusted, the processing system does not pass control to that code bock.

According to the present disclosure, a processing system may take advantage of access controls on the TPM NV storage, while providing a controlled launch point on the platform, to provide the ability to control the execution of software such as a VMM. The processing system may thus defeat hyperjacking and “BluePill” like attacks. More information on BluePill attacks is currently available at Internet sites such as theinvisiblethings.blogspot.com/2006/06/introducing-blue-pill.html.

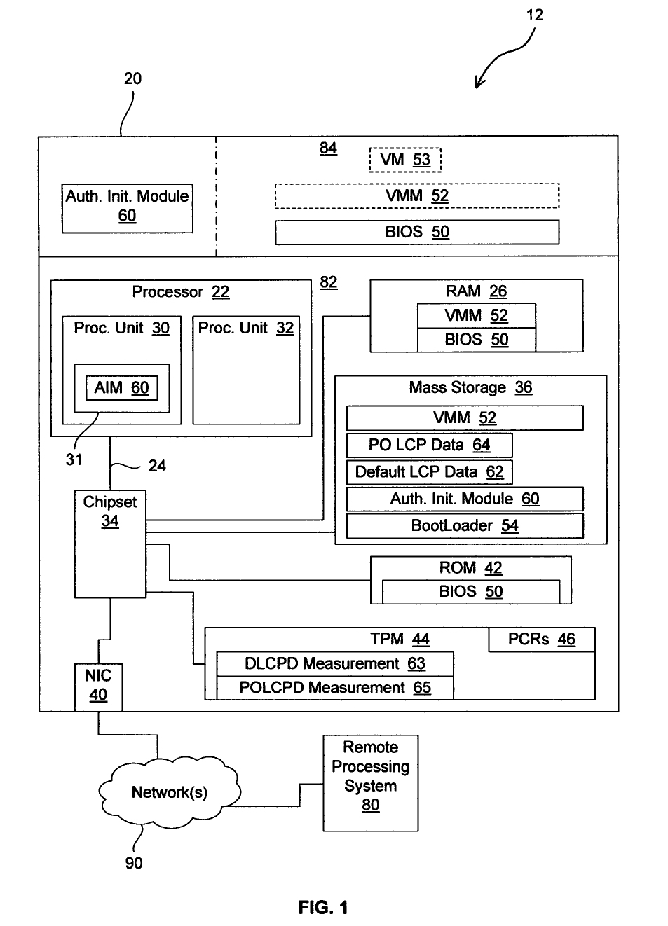

FIG. 1 is a block diagram depicting a suitable data processing environment 12 in which certain aspects of an example embodiment of the present invention may be implemented. Data processing environment 12 includes a local data processing system 20. Data processing system 20 has various hardware components 82, such as a central processing unit (CPU) 22, communicatively coupled to various other components via one or more system buses 24 or other communication pathways or mediums. This disclosure uses the term “bus” to refer to shared communication pathways, as well as point-to-point pathways. CPU 22 may include two or more processing units, such as processing unit 30 and processing unit 32. Alternatively, a processing system may include a CPU with one processing unit, or multiple processors, each having at least one processing unit. The processing units may be implemented as processing cores, as Hyper-Threading (HT) technology, or as any other suitable technology for executing multiple threads simultaneously or substantially simultaneously. In the example embodiment, at least processing unit 30 includes or has access to a protected memory area 31 that can be used for securely executing programs such as an AC module. Protected memory area 31 may be implemented as cache memory or any other suitable data storage facility within processing unit 30 or processor 22.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other devices for processing or transmitting information.

Processing system 20 may be controlled, at least in part, by input from conventional input devices, such as a keyboard, a mouse, etc., and/or by directives received from another machine, biometric feedback, or other input sources or signals. Processing system 20 may utilize one or more connections to one or more remote data processing systems 80, such as through a network interface controller (NIC) 40, a modem, or other communication ports or couplings. Processing systems may be interconnected by way of a physical and/or logical network 90, such as a local area network (LAN), a wide area network (WAN), an intranet, the Internet, etc. Communications involving network 90 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as WiMAX or wireless metropolitan area network protocols, and information concerning those protocols is currently available at grouper.ieee.org/groups/802/16/published.html.

Within processing system 20, processor 22 may be communicatively coupled to one or more volatile or nonvolatile data storage devices, such as RAM 26, read-only memory (ROM) 42, mass storage devices 36 such as hard drives, and/or other devices or media, such as floppy disks, optical storage, tapes, flash memory, memory sticks, digital video disks, etc. For purposes of this disclosure, the term “ROM” may be used in general to refer to nonvolatile memory devices such as erasable programmable ROM (EPROM), electrically erasable programmable ROM (EEPROM), flash ROM, flash memory, etc. For purposes of this disclosure, the terms “nonvolatile storage” and “NV storage” refer to disk drives, flash memory, and any other storage component that can retain data when the processing system is powered off. Processor 22 may also be communicatively coupled to additional components, such as a video controller, integrated drive electronics (IDE) controllers, small computer system interface (SCSI) controllers, universal serial bus (USB) controllers, input/output (I/O) ports, input devices, output devices such as a display, etc.

In the embodiment of FIG. 1, processing system 20 also includes a TPM 44. In other embodiments, other types of security coprocessors may be used. Processor 22, RAM 26, TPM 44, and other components may be connected to a chipset 34. Chipset 34 may include one or more bridges or hubs for communicatively coupling system components, as well as other logic and storage components.

In alternative embodiments, the chipset may include the TPM. For instance, the chipset may be implemented as a single hardware component that provides conventional chipset functionality and TPM functionality. In an alternative embodiment, a chipset may include two or more components, with one of those components providing TPM functionality, or more than one of those components cooperating to provide TPM functionality. For instance, the chipset may include secure nonvolatile memory with inherent access controls which prevent unauthorized access to the secure memory.

In processing system 20, some components (e.g., NIC 40) may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

The invention may be described herein with reference to data such as instructions, functions, procedures, data structures, application programs, configuration settings, etc. When the data is accessed by a machine, the machine may respond by performing tasks, defining abstract data types or low-level hardware contexts, and/or performing other operations, as described in greater detail below. The data may be stored in volatile and/or nonvolatile data storage. For purposes of this disclosure, the term “program” covers a broad range of software components and constructs, including applications, drivers, processes, routines, methods, modules, and subprograms. The term “program” can be used to refer to a complete compilation unit (i.e., a set of instructions that can be compiled independently), a collection of compilation units, or a portion of a compilation unit. Thus, the term “program” may be used to refer to any collection of instructions which, when executed by a processing system, perform a desired operation or operations. The programs in processing system 20 may be considered components of a software environment 84.

For instance, when processing system 20 boots, a BIOS 50 may be loaded into RAM 26 and executed within software environment 84. BIOS 50 may be implemented in accordance with Version 2.0 of the Unified Extensible Firmware Interface Specification, dated Jan. 31, 2006, for instance.

Processing system 20 may also include one or more sets of LCP settings. For instance, the entity that assembled processing system 20 may have provided processing system 20 with default LCP settings 62. Also, the entity that owns processing system 20 may have provided processing system 20 with customized LCP settings 64. The customized LCP settings 64 may also be referred to as platform owner (PO) LCP data 64. The LCP settings or data may be stored in any suitable NV storage, such as mass storage device 36 for example.

In addition, the platform supplier (PS) and the PO may store respective measurements of default LCP data 62 and PO LCP data 64 in TPM 44. For instance, hashing functions may be used to compute a default LCP data (DLCPD) measurement 63 and a customized PO LCP data (POLCPD) measurement 65. Before the PS releases the platform from manufacturing, the PS may choose to define a space using the TPM NV store's interface. The process of defining the space sets the access control permissions on the space. In the case of the PS, this space is write-once only. The PO may need to perform the same operation; however, the access control permissions on the PO's space allow the PO to change its LCP data on presenting authorization data.

The policy settings in default LCP data 62 may include a list of approved platform states, and a list of approved VMMs. PO LCP data 64 may also include a list of approved platform states, and a list of approved VMMs. In the example embodiment, each item in the list of approved platform states is enumerated as a TPM_PCR_INFO_SHORT structure, and all items in the list check the same set of PCRs. (Additional details on structures such as TPM_PCR_INFO_SHORT may be found in the TPM Specification, referenced above.)

In one embodiment, those PCRs reflect measurements of hardware components, as well as measurements of software components, such as BIOS 50 and boot loader 54. As described in greater detail below, this collection of measurements may be referred to collectively as the root of trust measurement (RTM). In addition, since this same set of hardware components should be present and this same set of software component should be launched whenever processing system 20 boots, this collection of measurements may be referred to as the static root of trust measurement (SRTM). Accordingly, the list of approved platform states may also be referred to as the SRTM list or the platform configuration list.

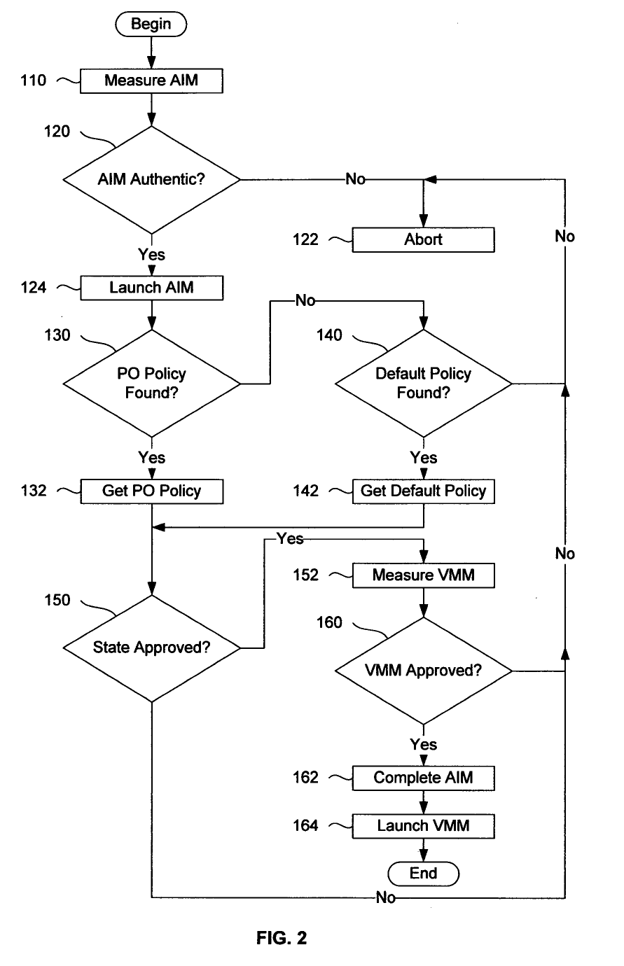

FIG. 2 depicts a flowchart of an example embodiment of a process for enforcing launching policies in the processing system of FIG. 1. The operations depicted in FIG. 2 may be executed after processing system 20 has launched BIOS 50. In particular, processing system 20 may execute the depicted operations as part of the boot process, or after completion of the boot process, in response to execution of an instruction to launch a VMM or to otherwise activate an environment that provides virtualization. For instance, the process of FIG. 2 may start in response to execution of a GETSEC[SENTER] instruction by processing unit 30. Also, in the example embodiment, processing unit 30 serves the bootstrap processor (BSP).

When GETSEC[SENTER] is executed, processing unit 30 may transfer control to an authenticated initialization module (AIM) 60. In the example embodiment, AIM 60 is implemented as an AC module with instructions for preparing processing unit 30 to launch or initiate a VMM. That AC module may also be referred to as a secure initialization (SINIT) module.

In the example embodiment, before processing system 20 is delivered to the PO, the SINIT code is signed using the private portion of an asymmetric key pair. This private key is held and only exercised by the manufacturer of chipset 34, while the public portion of the key is stored in chipset 34. A hash of the public portion may also be stored in the chipset for validation of the SINIT.

Referring again to FIG. 2, before transferring control to AIM 60, processing unit 30 measures AIM and determines whether AIM 60 is authentic, as shown at blocks 110 and 120. For instance, on execution of the GETSEC[SENTER] instruction, processing unit 30 may retrieve the public portion of the key and use it to determine whether the AIM is authentic. If AIM 60 has been tampered with, processing unit 20 aborts execution of the GETSEC[SENTER] without launching a VMM, as indicated at block 122. If AIM 60 is authentic, processing unit may then load AIM 60 into protected memory area 31, and may then pass control to AIM 60, as depicted at block 124.

In particular, the example processing system of FIG. 1 provides launch and control interfaces using functions known as safer mode extensions (SMX). Additional information concerning SMX may be obtained from the LTPA Specification. The LTPA Specification also describes how an AC module can be authenticated and executed. For example, pages 11 and 12 provide the following explanations:
To support the establishment of a protected environment, SMX enables the capability of an authenticated code execution mode. This provides the ability for a special code module, referred to as the authenticated code module (AC module), to be loaded into internal RAM (referred to as authenticated code execution area) within the processor. The AC module is first authenticated and then executed using a tamper resistant method.
Authentication is achieved through the use of a digital signature in the header of the AC module. The processor calculates a hash of the AC module and uses the result to validate the signature. Using SMX, a processor will only initialize processor state or execute the AC code module if it passes authentication. Since the authenticated code module is held within internal RAM of the processor, execution of the module can occur in isolation with respect to the contents of external memory or activities on the external processor bus, as all system interrupts at this time are disabled.

As shown at block 130, AIM 60 may then determine whether processing system 20 contains customized LCP settings. If customized LCP settings (e.g., PO LCP data 64) are found, AIM 60 may retrieve those settings, as shown at block 132. If no customized LCP settings are found, AIM 60 may determine whether processing system 20 contains default LCP settings, as shown at block 130. If default LCP settings (e.g., default LCP data 62) are found, AIM 60 may retrieve those settings, as shown at block 142.

AIM 60 may also determine whether or not the LCP settings should be trusted. For instance, the PS and PO may digitally sign their respective LCP settings before storing them in processing system 20. The PS and PO may also save hashes of the keys for their signatures in NV storage in TPM 44. AIM 60 may subsequently use those signatures to verify that the relevant LCP settings were provided by a trusted entity, and that those settings have not been altered. Also, AIM 60 may use the hash values in TPM 44 for the PS and PO keys (a) as a hash-based integrity metric of the LCP data stored in the processing system (as opposed to a hash of a public key) and (b) as a direct hash of the VMM or measured launch environment (MLE). As used herein, the term “MLE” refers to the VMM or like component(s) measured when the processing system executes an instruction for launching the VMM or for activating or enabling virtualization.

Referring again the FIG. 2, if no LCP settings are found, AIM 60 may cause processing unit 30 to abort execution of the GETSEC[SENTER] without launching a VMM, as shown at block 122. Alternatively, a processing system may extend an arbitrary value (e.g., “XXX”) to one of the PCRs (e.g., PCR[17]) to prevent any MLE from later extending a value of any other policy into the PCR.

If default or customized LCP settings have been retrieved and found to be trustworthy, AIM 60 may then use those settings, as well as data from TPM 44, to determine whether the current state of processing system 20 is an approved state, as shown at block 150.

For example, if processing system 20 has been configured to launch a VMM as part of the boot process, with BIOS 50 to call boot loader 54, and boot loader 54 to execute GETSEC[SENTER], the current state of processing system 20 at block 150 may be reflected in measurements stored in platform configuration registers (PCRs) 46 in TPM 44. For example, PCRs 46 may reflect the SRTM.

Alternatively, if GETSEC[SENTER] was called after additional software (e.g., an OS) had been launched, the measurement of the current state of processing system 20, as stored in PCRs 46, would constitute a dynamic root of trust measurement (DRTM). The DRTM may include measurements for components such as
the SINIT code (e.g., in PCR17),
the LCP policy (e.g., in PCR17),
any STM code (e.g., in PCR17), and
the VMM (e.g., in PCR18).
   To determine whether or not the current state should be trusted, AIM 60 may compare the current SRTM or DRTM with the list of approved state measurements. For instance, if processing system 20 includes customized LCP data, AIM 60 may compare the current RTM with the list of approved state measurements in PO LCP data 64. Alternatively, if processing system 20 only includes default LCP data 62, AIM 60 may compare the current RTM with the list of approved state measurements in default LCP data 62.

If AIM 60 determines that the measurement for the current state matches the predetermined approved state measurement, AIM 60 may then measure the candidate VMM, as shown at block 152. AIM 60 may then check a list of measurements for approved VMMs in the PO or PS LCP settings to determine whether the measurement for the candidate VMM matches an authorized VMM, as shown at block 160. If the candidate VMM is approved, AIM 60 may complete any operations needed to prepare processing system 20 to launch a VMM, and may then launch the approved VMM, as shown at blocks 162 and 164.

However, if AIM 60 determines that either the current state or the candidate VMM is not acceptable, AIM 60 aborts execution of the SINIT without launching a VMM, as indicated at block 122.

Referring again to FIG. 1, if AIM 60 approves and launches a VMM, that VMM may then create one or more VMs, and each VM may support an independent OS. For instance, if AIM 60 approves and launches VMM 52, VMM 52 may create one or more VMs 53. VMM 52 is shown with a solid outline in mass storage device 36 and RAM 26, because, as a candidate VMM, it may be copied from mass storage device 36 to RAM for measurement. However, VMM 52 and VM 53 are shown with dashed outlines in software environment 84 to indicate that, if AIM 60 does not approve of VMM 52, VMM 52 may never be launched.

Once AIM 60 measures and launches a VMM, that VMM may serve as the software basis for a virtualization environment that may include multiple VMs. A measured VMM may also be referred to as an MLE.

In light of the principles and example embodiments described and illustrated herein, it will be recognized that the illustrated embodiments can be modified in arrangement and detail without departing from such principles. For instance, instead of measuring and launching a VMM, the techniques described above could be used in alternative embodiments to enforce policies for measuring and launching other types of environments, such as an application that executes on top of an OS.

Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, ROM, and RAM; and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. A processing system comprising:
a processing unit;
nonvolatile storage in communication with the processing unit;
secure nonvolatile memory with inherent access control in communication with the processing unit;
an authenticated code (AC) module in the nonvolatile storage;
a launch policy setting in the nonvolatile storage;
a second code module in the nonvolatile storage; and
an integrity metric for the launch policy setting in the secure nonvolatile memory;
wherein the AC module, when executed by the processing unit, performs operations comprising:
computing a new integrity metric for the launch policy setting;
computing a new integrity metric for the second code module;
using (a) the new integrity metric for the launch policy setting and (b) the integrity metric for the launch policy setting in the secure nonvolatile memory to determine whether the launch policy setting should be trusted; and
in response to a determination that the launch policy setting should be trusted, using (a) the launch policy setting and (b) the new integrity metric for the second code module to determine whether the second code module should be allowed to execute.

2. A processing system according to claim 1, wherein:
the second code module comprises a candidate virtual machine monitor (VMM); and
the launch policy setting comprises data to identify at least one approved VMM.

3. A processing system according to claim 1, wherein the nonvolatile storage comprises a hard disk drive.

4. A processing system according to claim 1, wherein:
the AC module and the second code module both reside in a single nonvolatile storage component.

5. A processing system according to claim 1, wherein the AC module, when executed by the processing unit, performs operations comprising:
determining whether the processing system has a customized launch policy setting;
if the processing system has a customized launch policy setting, determining whether the second code module should be allowed to execute, based at least in part on the customized launch policy setting; and
if the processing system does not have a customized launch policy setting, determining whether the second code module should be allowed to execute, based at least in part on a default launch policy setting,

6. A processing system according to claim 1, wherein:
the launch policy setting comprises data provided by at least one entity from the group consisting of:
a supplier of the processing system; and
an owner of the processing system.

7. A processing system according to claim 1, further comprising:
cache memory in the processing unit, the processing unit to use the cache memory as random access memory (RAM) to execute the AC module.

8. A processing system according to claim 1, further comprising:
the processing unit to execute the AC module in response to execution of an instruction to launch a virtual machine monitor (VMM).

9. An apparatus comprising:
a machine-accessible medium; and
an authenticated code (AC) module in the machine-accessible medium, wherein the AC module, when executed by a processing unit in a processing system, causes the processing unit to perform operations comprising:
computing an integrity metric for launch control policy (LCP) data stored in nonvolatile (NV) storage in the processing system; and
computing an integrity metric for a candidate code module; and
using the integrity metric for the LCP data and a predetermined integrity measurement from secure nonvolatile memory in the processing system to determine whether the LCP data should be trusted, the secure nonvolatile memory having inherent access control; and
in response to a determination that the LCP data should be trusted, determining whether the candidate code module should be allowed to execute, based at least in part on (a) the LCP data from the NV storage and (b) the integrity metric for the candidate code module.

10. An apparatus according to claim 9, wherein the AC module comprises a digital signature to attest to contents of the AC module.

11. An apparatus according to claim 9, further comprising:
the AC module to execute automatically in response to an instruction to launch the candidate code module.

12. An apparatus according to claim 9, wherein:
the candidate code module comprises a candidate virtual machine monitor (VMM); and
the LCP data comprises information to identify at least one approved VMM.

13. An apparatus according to claim 9, wherein the operations to be performed by the AC module further comprise:
causing the processing system to launch the candidate code module in response to a determination that the candidate code module should be allowed to execute.

14. An apparatus according to claim 9, wherein:
the AC module comprises an initialization module to execute automatically in response to execution of an instruction to launch a virtual machine monitor (VMM).

15. An apparatus according to claim 9, wherein:
the AC module comprises an initialization module to execute automatically in a protected storage area of the processing unit, in response to execution of an instruction to launch a virtual machine monitor (VMM).
